(19) United States
(12) Patent Application Publication
(10) Pub. No.: US 2008/0277625 A1
(43) Pub. Date: Nov. 13, 2008

(54) Phosphor And Production Process Of Same

(75) Inventors: Hiroyuki Nakamura, Saga (JP); Hideaki Maeda, Saga (JP); Takahisa Omata, Osaka (JP); Masato Uehara, Saga (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: NAT'L INSTITUTE OF ADVANCED INDUSTRIAL SCIENCE AND TECHNOLOGY, Tokyo (JP); OSAKA UNIVERSITY, Osaka (JP)

(21) Appl. No.: 11/632,288

(22) PCT Filed: Jul. 15, 2005
(86) PCT No.: PCT/JP2005/013185

§ 371 Date: Mar. 4, 2008

(30) Foreign Application Priority Data
Jul. 16, 2004 (JP) 2004-210548

(51) Int. Cl. C09K 11/56; C09K 11/08

(52) U.S. Cl. 252/301.4 S; 252/301.4 R

(57) ABSTRACT

The present invention provides a lowly toxic phosphor and a production process thereof, and more particularly, the synthesis of nanoparticles having a chalcopyrite structure, a phosphor by compounding with a metal chalcogenite, and a production process thereof. The phosphor is a first compound composed of elements of groups I, III and VI having a chalcopyrite structure, or composite particles or composite compound containing the first compound, and the particle diameter of the first compound, or the composite particles or composite compound, is 0.5 to 20.0 nm. The phosphor is produced by mixing a first solution (Solution A), in which one or more of copper (I), copper (II), silver (I), indium (III), gallium (III) and aluminum (III) are respectively dissolved and mixed in a solution to which has been added a complexing agent, and a second solution (Solution C), in which a chalcogenite compound has been dissolved, followed by heat-treating under pre-determined synthesis conditions.

### BACKGROUND OF THE INVENTION

1. Field of the Invention

The present invention relates to a phosphor and a production process thereof, more particularly, to a phosphor which generates near infrared fluorescent light from visible light, and a production process thereof, and even more particularly, to a phosphor containing semiconductor nanoparticles capable of carrying out modification, staining and so on of bio-related substances, a phosphor for a semiconductor light source used in illumination, displays and so on, and a production process thereof.

2. Description of the Related Art

When a semiconductor is reduced in size to the nanometer order, quantum size effects appear, and the energy band gap increases accompanying a reduction in the number of atoms. Semiconductor fluorescent nanoparticles comprised of a semiconductor of the nanometer order emit fluorescent light equivalent to the band gap energy of the semiconductor. The fluorescent color of CdSe nanoparticles of group II and VI semiconductors can be adjusted as desired within the range of about 500 to 700 nm by adjusting the particle diameter as a result of utilizing quantum size effects, and extensive research has been conducted on these nanoparticles due to their highly fluorescent properties (Published Japanese Translation of PCT Application No. 2003-524147).

Because they are inorganic semiconductors, they have been suggested to have the potential for use as fluorescent materials of fluorescent tags for biochemical analyses, illumination, displays and so on due to being more stable than organic pigments. Nanoparticles which generate fluorescence of visible light at room temperature have also been developed with group III and V semiconductors, silicon and germanium. Moreover, chalcopyrite compounds are semiconductor compounds which have been suggested to be used as absorbers and so on.

However, since the toxicity of Cd and Se presents a considerable environmental risk during production and use, and since group III and V semiconductors and silicon and other group IV semiconductors, which have comparatively low toxicity and generate fluorescence in the visible light range, demonstrate a high degree of covalent bonding, thereby requiring a complex processes during production thereof, it is difficult to deploy these semiconductors in a wide range of industrial applications. Therefore, the inventors of the present invention conducted extensive research activities for the purpose of creating novel semiconductor fluorescent nanoparticles composed of lowly toxic elements. During this research, attention was focused on a compound having a chalcopyrite structure similar to the physical properties of CdSe, and particularly CuInS₂, as a target material, and this compound was then compounded with ZnS and other group II and VI compounds followed by evaluation of fluorescence characteristics, thereby leading to completion of the present invention.

### SUMMARY OF THE INVENTION

In consideration of this technical background, the present invention achieves the following objects.

An object of the present invention is to provide a lowly toxic phosphor and a production process thereof.

An other object of the present invention is to provide a phosphor resulting obtained by synthesizing a compound having a chalcopyrite structure and compounding with a group II and VI compound such as ZnS, and a production process thereof.

Still another object of the present invention is to provide a compound obtained by synthesizing a compound having a chalcopyrite structure and compounding with a group III and V compound, and a production process thereof.

The present invention employs the following means to achieve the above-mentioned objects.

[Phosphor]

A phosphor of the present invention provides a phosphor comprising a first compound composed of elements of groups I, III and VI having a chalcopyrite structure, or composite particles or composite compound containing the first compound. The particle diameter of the first compound, or the composite particles or composite compound, is 0.5 to 20.0 nm.

The composite compound is a compound other than the first compound, is composed of elements of groups II and VI or groups III and V, forms a solid solution with the first compound, and is preferably a compound which forms a band gap.

In addition, the composite particles or composite compound contains a second compound other than the first compound composed of group II and VI or group III and V elements and having a band gap larger than the band gap of the first compound, and the lattice mismatch ratio between the lattice constant of the first compound and the lattice constant of the second compound is preferably 5% or less.

The first compound is composed of the elements of copper (Cu), indium (In) and sulfur (S), the second compound is zinc sulfide (ZnS), the composite particles or composite compound is preferably produced from raw materials in which A is 0.5 to 5.0 and B is 0.5 to 5.0 for a composite ratio (feed ratio) of the zinc (Zn), copper (Cu), indium (In) and sulfur (S) of the raw materials of 1:A:B:4. Furthermore, the composite ratio does not refer to the composite ratio of the phosphor, but rather to the feed ratio (moles) of the raw materials.

The first compound is composed of the elements of silver (Ag), indium (In) and sulfur (S), the second compound is zinc sulfide (ZnS), and the composite particles or composite compound is preferably produced from raw materials in which A is 0.5 to 5.0 and B is 0.5 to 5.0 for a composite ratio (feed ratio) of zinc (Zn), silver (Ag), indium (In) and sulfur (S) of 1:A:B:4.

Moreover, the first compound preferably has a quantum efficiency of emission of light waves following excitation by excitation light of 0.1% to 10.0% at room temperature. The fluorescence emitted by the first compound consists of light waves having a wavelength of 550 to 800 nm.

[Phosphor Production Process]

The phosphor production process of the present invention comprises mixing a first solution, in which a raw material salt of a plurality of types of elements composing a compound having a chalcopyrite structure is dissolved and mixed in a solution to which has been added a complexing agent which coordinates to the plurality of types of elements, and a second solution in which a chalcogenite compound has been dissolved, and heat-treating the mixture under predetermined heating conditions.

Examples of compounds which can be used for the chalcogenite compound include metal salts of zinc, cadmium, magnesium, manganese, nickel, copper, lead, sulfur and so on with dithiocarbaminates such as dimethyldithiocarbaminate, diethyldithiocarbaminate or dihexyldithiocarbaminate, xanthogenic acids such as hexadecylxanthogenic acid or dodecylxanthogenic acid, trithiocarbonates such as hexadecyltrithiocarbonate or dodecyltrithiocarbonate or dithiophosphoric acids such as hexadecyldithiophosphoric acid or dodecyldithiophosphoric acid, thioacetoamides, alkyl thiols, thiourea and derivatives thereof, and compounds which generate chalcogens such as sulfur, selenium or tellurium as a result of being decomposed by heating, such as trioctylphosphine selenide and trioctylphosphine telluride.

The predetermined conditions preferably consist of mixing the first solution and the second solution, and heat-treating the mixture at a temperature of 70 to 350° C. In addition, the predetermined conditions preferably consist of mixing the first solution and the second solution, and heat-treating the mixture for 1 second to 30 hours. The predetermined conditions also preferably consist of mixing the first solution and the second solution in a micro-reactor having a flow channel of 50 μm to 5 mm, followed by reacting by heating. Moreover, the sulfur compound is preferably zinc sulfide (ZnS).

The first solution is preferably a solution obtained by dissolving and mixing copper (I) or a copper (II) salt and an indium (III) salt in a solution containing a complexing agent which coordinates copper (I) and indium (III). The phosphor is produced from raw materials in which A is 0.5 to 5.0 and B is 0.5 to 5.0 for a composite ratio (feed ratio) of the zinc (Zn), copper (Cu), indium (In) and sulfur (S) of 1:A:B:4.

The first solution is preferably a solution obtained by dissolving and mixing a silver (I) salt and an indium (III) salt in a solution containing a complexing agent which coordinates silver (I) and indium (III). The phosphor is produced from raw materials in which A is 0.5 to 5.0 and B is 0.5 to 5.0 for a composite ratio (feed ratio) of the zinc (Zn), silver (Ag), indium (In) and sulfur (S) of 1:A:B:4.

Although the first compound in the form of a compound having a chalcopyrite structure composed of elements of groups I, III and VI may be any such typically known compound, it is particularly preferably a compound containing one or more types of elements among Cu and Ag as group I elements, among In, Ga and Al as group III elements, and among S, Se and Te as group VI elements, respectively.

Although the mixing ratio of the chalcopyrite compound and the compound to be compounded therewith can be varied as desired within a range that allows the formation of a solid solution or composite structure, the mixing ratio is preferably such that the compound to be compounded is compounded at a molar ratio of 0.05 to 3.00, and preferably 0.1 to 3.0, based on a group I element of the chalcopyrite compound. The phosphor described above may be spherical or spindle-shaped.

The following effects are demonstrated by the present invention.

A phosphor of the present invention, and a production process thereof, are able to provide a lowly toxic, semiconductor nanoparticle phosphor since the phosphor is a compound comprising elements of groups I, III and VI having a chalcopyrite structure, which is considered to have low toxicity, or composite particles or composite compound containing the compound, and these composite particles or the composite compound contains elements of groups II and VI or groups III and V.

In addition, a product which demonstrates near ultra violet fluorescence from visible light can be obtained by changing the phosphor synthesis conditions.

### BRIEF DESCRIPTION OF THE DRAWINGS

FIG. 1 shows a graph of the fluorescence intensity of a phosphor of Example 1;

FIG. 2 is a graph showing the results of forming a phosphor at a plurality of synthesis temperatures;

FIG. 3 shows the optical spectra emitted by a phosphor at a plurality of excitation wavelengths;

FIG. 4 shows a graph of fluorescence intensity in the case of changing the composite ratio (feed ratio) of raw materials;

FIG. 5 shows a graph of the optical absorbance of each phosphor in the graph of FIG. 4;

FIG. 6 shows emission spectra according to the molar ratios of atoms composing the phosphors of FIG. 4;

FIG. 7 shows the results of XRD diffraction analysis for the product in Example 1;

FIG. 8 shows a graph of the fluorescence intensity of a phosphor of Example 2;

FIG. 9 shows a graph of the optical absorbance of the phosphor of FIG. 8;

FIG. 10 shows a graph of the fluorescence intensity of a phosphor of Example 3;

FIG. 11 shows a graph of the optical absorbance of the phosphor of FIG. 10;

FIG. 12 shows a graph of the fluorescence intensity of a phosphor of Example 4;

FIG. 13 is a graph indicating the maximum values of absorption wavelength and the maximum values of fluorescence wavelength in Example 5;

FIG. 14 shows the results of measuring fluorescence intensity of product ZnS composite structure particles in Example 6; and,

FIG. 15 shows the results of measuring fluorescence intensity of a product in Example 7.

### DESCRIPTION OF THE PREFERRED EMBODIMENTS

### Example 1

The following indicates an Example 1 of producing a phosphor of the present invention. Preparation of the reaction solutions used in this research was entirely carried out in an argon atmosphere using argon gas. Copper (I) iodide and indium (III) iodide were respectively dissolved in a complexing agent in the form of oleyl amine followed by mixing using octadecene as a solvent to obtain Solution A. Zinc diethyldithiocarbaminate was dissolved in trioctylphosphine followed by mixing with octadecene to obtain Solution C. Solutions A and C were then mixed and heated for a predetermined amount of time at 160 to 280° C. The resulting product was diluted with toluene followed by measurement of absorption and fluorescence spectra. The measurement results were then graphed.

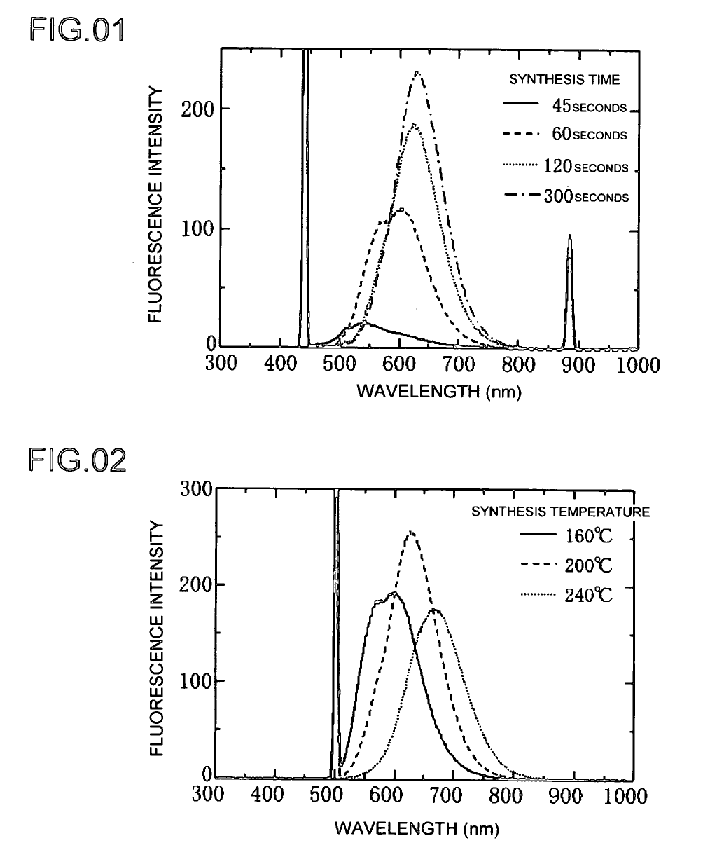

The graph of FIG. 1 shows the results of forming a phosphor at a plurality of synthesis times. FIG. 1 shows the spectra of light waves emitted by the formed phosphor versus intensity. Each graph shows the case of synthesis times of 45, 60, 120 and 300 seconds. Fluorescence intensity is plotted on the vertical axis of the graph of FIG. 1, while wavelength is plotted on the horizontal axis. Fluorescence intensity is represented with an arbitrary, relative value (to apply similarly herein after). The units of wavelength are nanometers (to apply similarly herein after). The composite ratio (feed ratio) of each raw material of the phosphor in the form of Zn, Cu, In and S is 1.0:1.0:1.0:4.0.

FIG. 2 shows the results for forming a phosphor at a plurality of synthesis temperatures. FIG. 2 shows the spectra of light waves emitted by the formed phosphor versus intensity. Each graph shows the case of synthesis temperatures of 160, 200 and 240° C. Fluorescence intensity is plotted on the vertical axis of the graph of FIG. 2, while wavelength is plotted on the horizontal axis. The composite ratio (feed ratio) of each raw material of the phosphor in the form of Zn, Cu, In and S is 1.0:1.0:1.0:4.0.

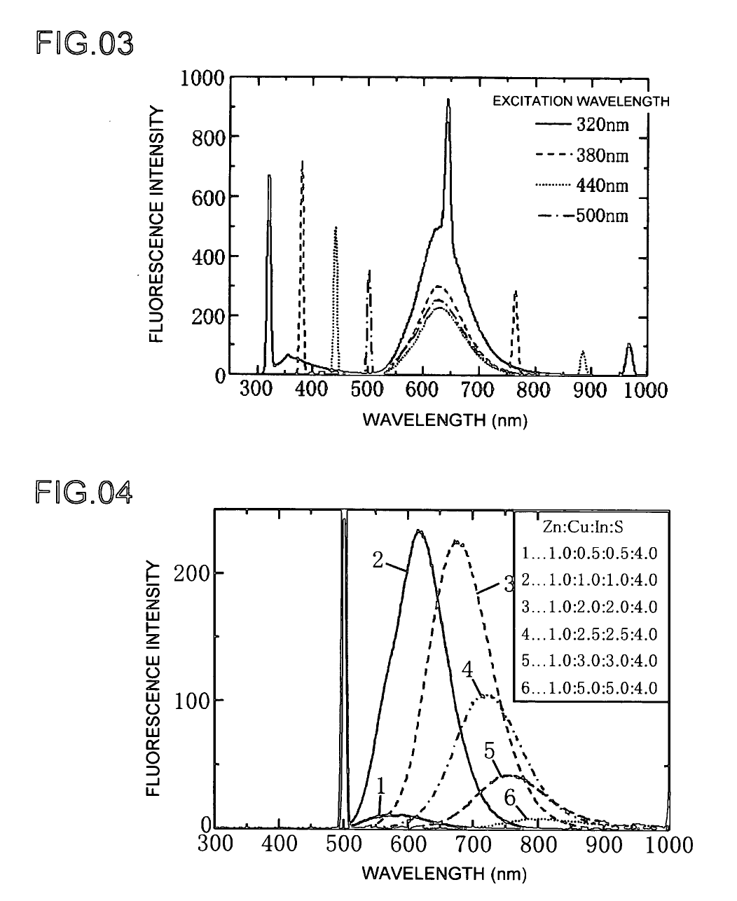

FIG. 3 shows the spectra of light waves emitted by a phosphor following irradiation with excitation light at a plurality of wavelengths. Each graph shows the case of excitation light wavelengths of 320 nm, 380 nm, 440 nm and 500 nm. Fluorescence intensity is plotted on the vertical axis of the graph of FIG. 3, while wavelength is plotted on the horizontal axis. The composite ratio (feed ratio) of each raw material of the phosphor in the form of Zn, Cu, In and S is 1.0:1.0:1.0:4.0.

FIG. 4 shows a graph of fluorescence intensity in the case of changing the raw material composite ratio (feed ratio). The composite ratio (feed ratio) for each plot is shown in Table 1. In FIG. 4, fluorescence intensity is plotted on the vertical axis of the graph, while wavelength is plotted on the horizontal axis.

TABLE 1

| | Raw Material Composite Ratio | |
|---|---|---|
| Plot Number | Zn:Cu:In:S | Quantum Yield |
| 1 | 1.0:0.5:0.5:4.0 | 0.1% or less |
| 2 | 1.0:1.0:1.0:4.0 | 6.0% |
| 3 | 1.0:2.0:2.0:4.0 | 6.0% |
| 4 | 1.0:2.5:2.5:4.0 | 3.0% |
| 5 | 1.0:3.0:3.0:4.0 | 2.0% |
| 6 | 1.0:5.0:5.0:4.0 | 0.1% or less |

The quantum yield indicating the proportion of photons emitted by fluorescence relative to the number of photons of excitation light absorbed by each of the phosphors of the graph of FIG. 4 is shown in Table 1. Quantum yield refers to the result of dividing the number of photons in the process of fluorescence by the number of photons absorbed by the particles. This value is determined by using rhodamine B and the like having a known quantum yield as a standard based on a relative comparison of the optical absorbance (to be defined later) and fluorescence intensity.

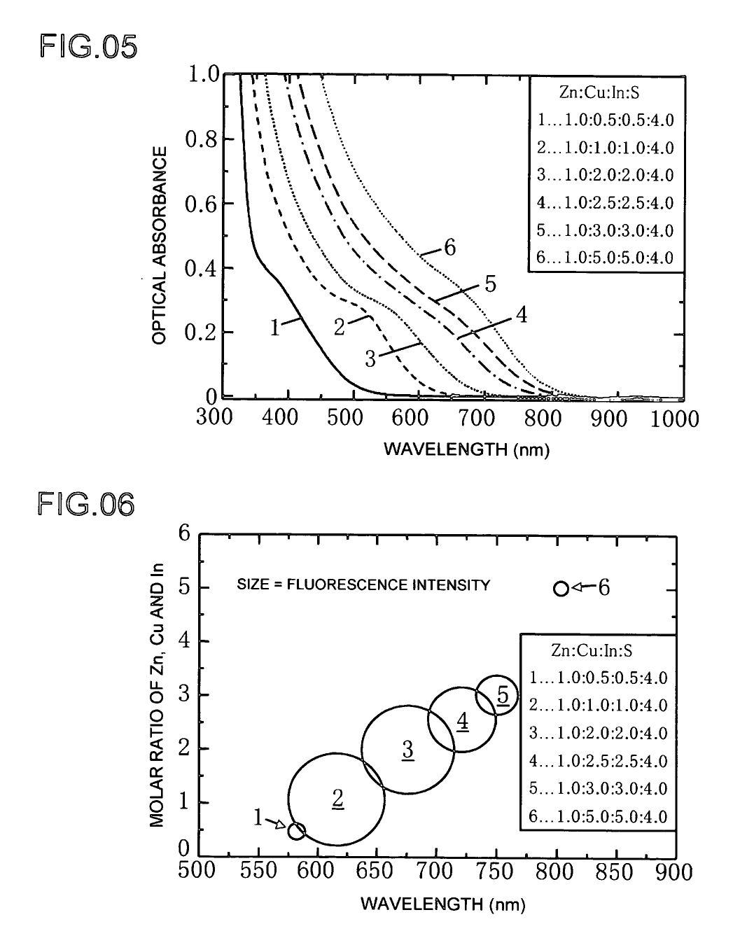

FIG. 5 shows the optical absorbance indicating the amount of excitation light absorbed by each phosphor in the graph of FIG. 4. In FIG. 6, optical absorbance is plotted as a relative value on the vertical axis of the graph, while wavelength is plotted on the horizontal axis. Optical absorbance is a physical value defined in the manner described below. Optical absorbance A is defined as follows by representing the intensity of incident light as I₀, and the intensity of transmitted light as I.

A=log(I/I₀) (1)

FIG. 6 shows emission spectra according to the molar ratio of the atoms Zn, Cu and In composing each phosphor of the graph of FIG. 4. The molar ratio of Zn, Cu and In is plotted on the vertical axis of the graph of FIG. 6, while wavelength is plotted on the horizontal axis. The composite ratio (feed ratio) for each plot is the same as the values shown in Table 1. The size of the circles in FIG. 6 corresponds to the magnitude of fluorescence intensity.

The Cu/Zn ratio (molar ratio) in the reaction solution of Example 1, the Cu/Zn ratio (molar ratio) in the product, and the average particle diameter of the product were determined and shown in Table 2.

TABLE 2

| | | | | | |
|---|---|---|---|---|---|
| Cu/Zn ratio (molar ratio) in reaction | 0.5 | 1.0 | 2.0 | 3.0 | 5.0 |
| solution | | | | | |
| Cu/Zn ratio (molar ratio) in product | 0.1 | 0.4 | 0.9 | 1.6 | 2.7 |
| Avg. particle diameter of product (nm) | 2.6 | 3.5 | 4.5 | 4.4 | 4.0 |

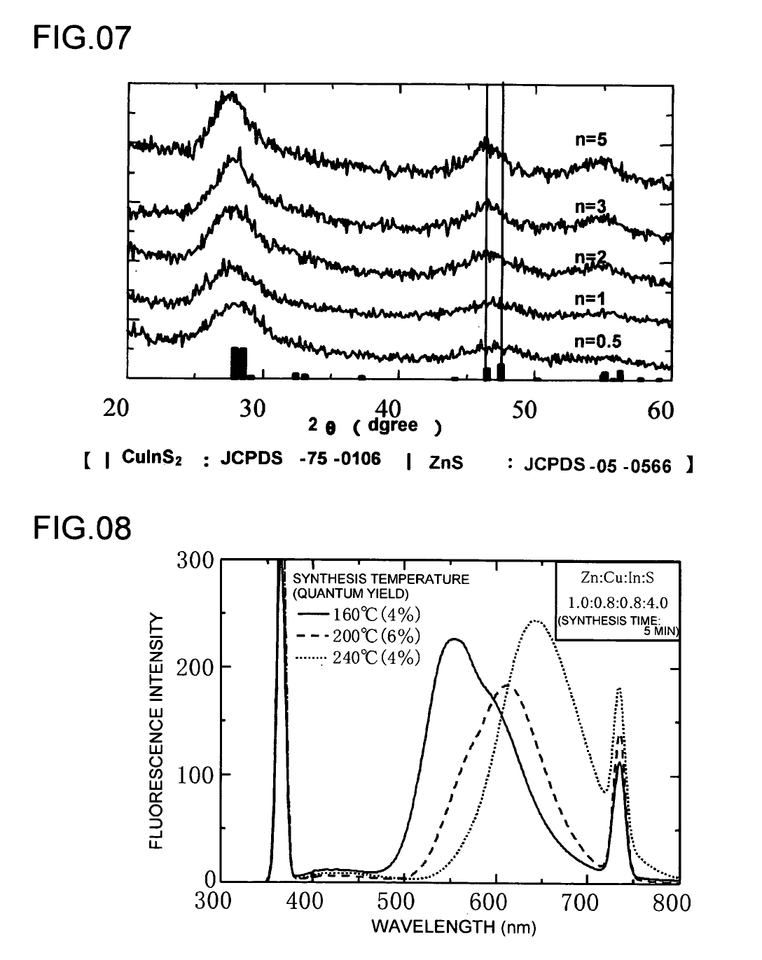

The product of Example 1 was measured by X-ray diffraction, and those results are shown in the chart of FIG. 7. The feed composition in the chart of FIG. 7 as Zn:Cu:In:S is 1.0:n:n:4.0. The black line immediately above the horizontal axis (X axis) of the chart of FIG. 7 indicates the diffraction line of bulk CuInS₂, while the gray line indicates the diffraction line of bulk ZnS (source: JCPDS database). This chart indicates that the product basically exhibits a chalcopyrite structure and a wurtzite structure. The product of Example 1 ranged from a spindle-like shape to a nearly spherical shape.

### Example 2

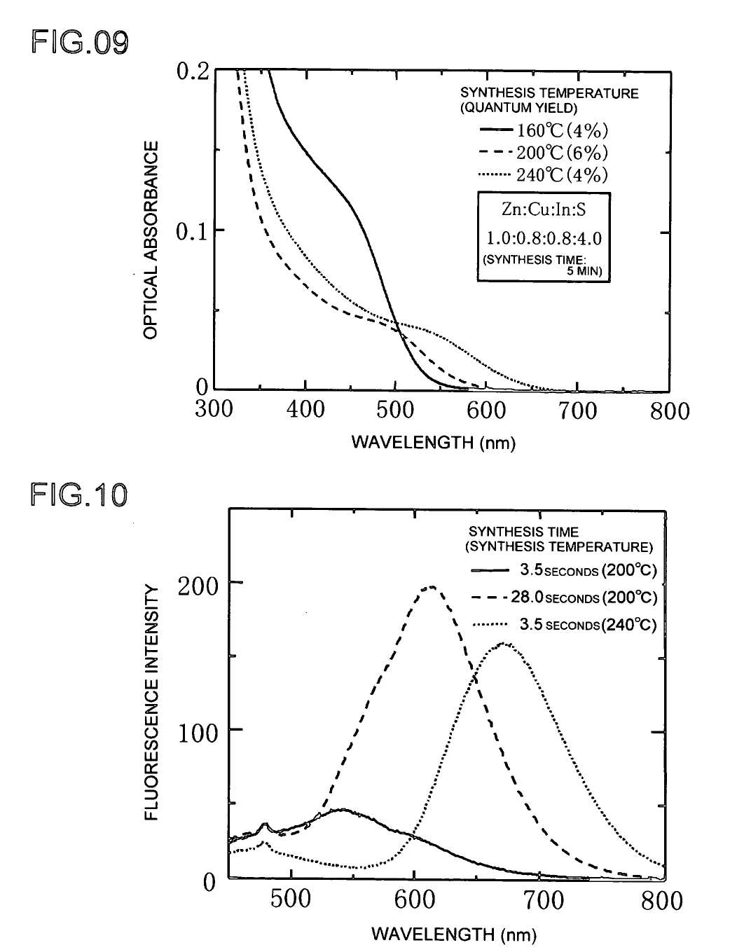

Next, Example 2 shows a different example of the production of a phosphor of the present invention. Example 2 is basically the same as Example 1, and differences between the two are described below. The composite ratio of the phosphor raw materials as Zn:Cu:In:S is 1.0:0.8:0.8:4.0. The results of measuring the characteristics of the formed phosphor were graphed. The optical absorbance of the phosphor for each of the plots in FIG. 8 is shown in the graph of FIG. 9. The graph of FIG. 8 shows the fluorescence intensity emitted by the formed phosphor as a result of heat-treating at predetermined temperatures of 160, 200 and 240° C. The heating time is 5 minutes.

Fluorescence intensity is plotted on the horizontal axis of the graph of FIG. 8, while wavelength is plotted on the horizontal axis. The quantum yields of the phosphor formed by heat-treating for 5 minutes at predetermined temperatures of 160, 200 and 240° C. were 6, 4 and 6%, respectively. Quantum yield refers to the product of dividing the number of photons in the process of fluorescence by the number of photons absorbed by the particles. This value is determined by using rhodamine B and the like having a known quantum yield as a standard based on a relative comparison of the optical absorbance (to be defined later) and fluorescence intensity. Optical absorbance of excitation light of the phosphor is plotted on the vertical axis of the graph of FIG. 9, while wavelength is plotted on the horizontal axis.

### Example 3

Example 3 shows an example of producing a phosphor of the present invention. The production process of Example 3 is basically the same as the previously described Examples 1 and 2, and the differences there between are described below. Copper (I) iodide and indium (III) iodide were respectively dissolved in a complexing agent in the form of dodecyl amine followed by mixing using octadecene as a solvent to obtain Solution A. The concentration of copper (Cu) at this time was 0.1 mmol, that of indium (In) was 0.1 mmol, the amount of dodecyl amine was 2 ml, and the amount of octadecene was 5 ml.

Zinc diethyldithiocarbaminate was dissolved in trioctylphosphine to obtain Solution C. The concentration of zinc (Zn) at this time was 0.13 mmol, that of sulfur (S) was 0.26 mmol, and the amount of trioctylphosphine was 7 ml. Solution A and Solution C were mixed with a mixer followed by heating for a predetermined amount of time at a temperature of 160 to 240° C. in a micro-reactor. The results of measuring the formed phosphor were graphed.

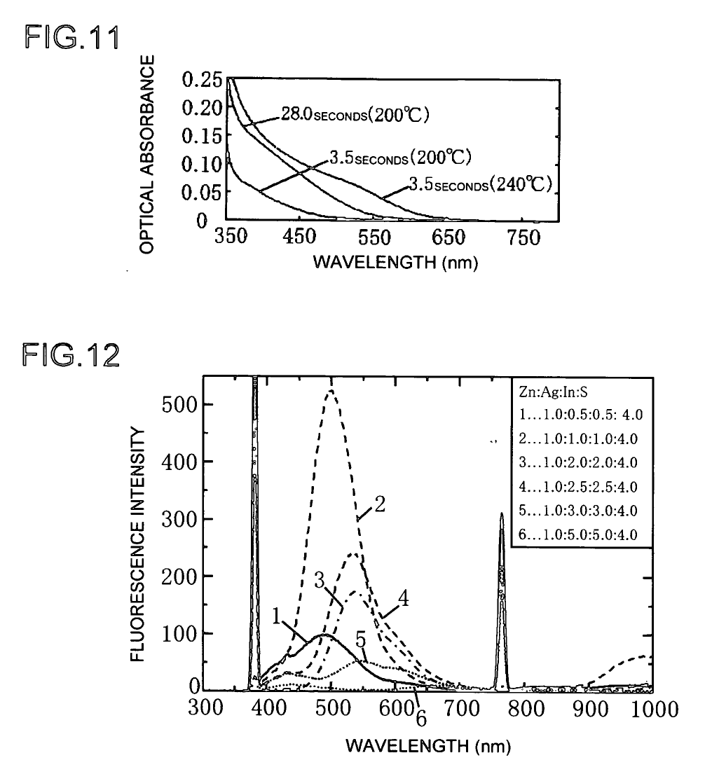

The graph of FIG. 10 shows the fluorescence intensity emitted by the phosphor by exciting the phosphor with excitation light of 420 nm following heat treatment at predetermined temperatures of 200 and 240° C. The heating times were 3.5 and 28.0 seconds. Fluorescence intensity is plotted on the vertical axis of the graph of FIG. 10, while wavelength is plotted on the horizontal axis. The maximum excitation wavelengths were 538 nm, 614 nm and 672 nm, and the spectral half-widths (FWHM) at those times were 136 nm, 102 nm and 100 nm, respectively. FIG. 11 shows the optical absorbance of excitation light of the phosphor corresponding to the graph of FIG. 10. The excitation light optical absorbance of the phosphor is plotted on the vertical axis, while wavelength is plotted on the horizontal axis.

### Example 4

Example 4 shows another example of producing a phosphor of the present invention. The production process of Example 4 is basically the same as the previously described Example 1, and only the differences there between are described below. Acetic acid and indium acetate were respectively dissolved in a complexing agent in the form of oleyl amine followed by mixing using octadecene as a solvent to obtain Solution A. Zinc diethyldithiocarbaminate was dissolved in trioctylphosphine followed by mixing with octadecene to obtain Solution C.

Solution A and Solution C were then mixed and heated for a predetermined amount of time at 160 to 280° C. The resulting product was diluted with toluene followed by measurement of the absorption and fluorescent spectra. The measurement results were then graphed and shown in FIG. 12. Fluorescence intensity is plotted on the vertical axis of the graph of FIG. 12, while wavelength is plotted on the horizontal axis. The composite ratio (feed ratio) of the raw materials for each plot in FIG. 12 is shown in Table 3. The heating conditions consisted of a synthesis temperature of 200° C. and synthesis time of 300 seconds.

TABLE 3

| Plot Number | Zn:Ag:In:S |
|---|---|
| 1 | 1.0:0.5:0.5:4.0 |
| 2 | 1.0:1.0:1.0:4.0 |
| 3 | 1.0:2.0:2.0:4.0 |
| 4 | 1.0:2.5:2.5:4.0 |
| 5 | 1.0:3.0:3.0:4.0 |
| 6 | 1.0:5.0:5.0:4.0 |

### Example 5

Example 5 shows another example of producing a phosphor of the present invention. The production process of Example 5 is basically the same as the previously described Example 1, and only the differences there between are described below. Gallium iodide, copper iodide and indium iodide were respectively dissolved in a complexing agent in the form of oleyl amine followed by mixing using octadecene as a solvent to obtain Solution A. Zinc diethyldithiocarbaminate was dissolved in trioctylphosphine followed by mixing with octadecene to obtain Solution C.

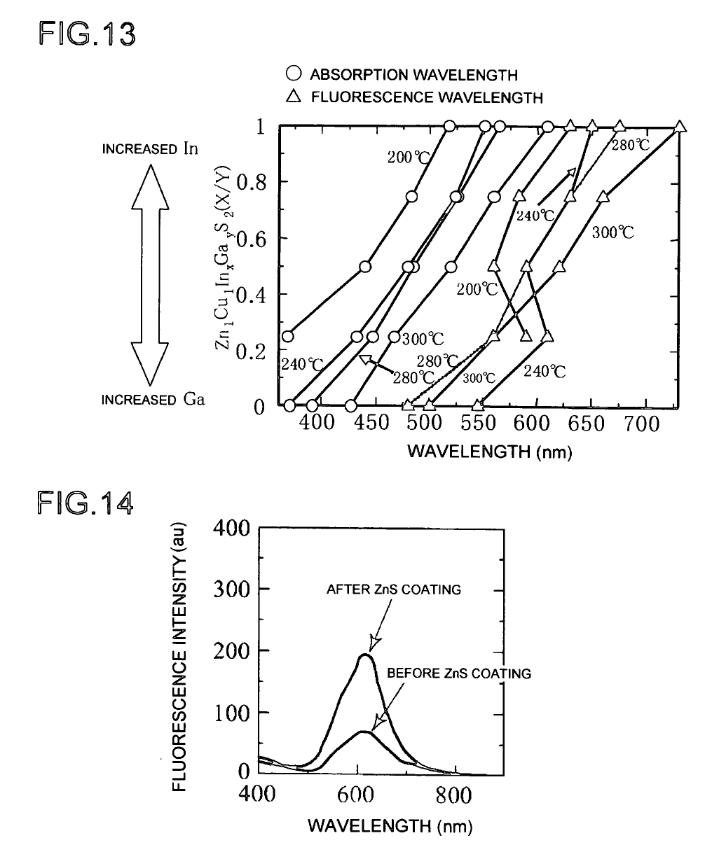

Solution A and Solution C were then mixed and heated for a predetermined amount of time at 200° C. The resulting product was diluted with toluene followed by measurement of the absorption and fluorescent spectra. The maximum value of the absorption wavelength and the maximum value of the fluorescence wavelength were read from the measurement results and then graphed and shown in FIG. 13. The circles in the graph indicate absorption wavelengths, while the triangles indicate fluorescence wavelengths. The maximum values of absorption wavelength and maximum values of fluorescence wavelength are plotted on the horizontal axis of the graph of FIG. 13, while the ratio of In/Ga (molar ratio) in the raw material is plotted on the vertical axis.

The synthesis temperatures were as indicated in the graph of FIG. 13, and the synthesis time was 300 seconds. As shown in the graph, the maximum values of absorption wavelength and fluorescence wavelength are able to be controlled according to the molar ratio of In and Ga and the heating temperature. In addition, the maximum value of the fluorescence wavelength is shown to be able to be controlled within the range of 475 to 725 nm depending on the In/Ga ratio and the heating temperature.

### Example 6

Example 6 shows another example of producing a phosphor of the present invention. The production process of Example 6 is basically the same as the previously described Example 1, and only the differences there between are described below. Zinc bis-diethyldithiocarbaminate was added to the product obtained by the same process as described in the above-mentioned Example 1 using the raw materials of Zn, Cu, In and S in the ratio of 1.0:1.0:1.0:4.0 in Example 1, followed by heating for 5 minutes at 200° C. to synthesize composite particles having a ZnS shell. The fluorescence intensity of the resulting ZnS composite structure particles was measured. The excitation wavelength during measurement was 340 nm. FIG. 14 shows the measurement results. As shown in FIG. 14, an increase in fluorescence intensity was observed.

### Example 7

Example 7 shows an example of producing a phosphor of the present invention. Synthesis was carried out using trioctylphosphine selenide as a selenium source, octadecene as a solvent and oleylamine as a complexing agent. Zinc acetate, copper (II) acetate and indium iodide were completely dissolved in oleyl amine and mixed with octadecene followed by mixing with trioctylphosphine selenide dissolved in trioctylphosphine. This solution was then heated for 5 minutes at a temperature of 220° C. to obtain a product. The resulting product generated fluorescent light having a fluorescence wavelength of 600 nm as a result of optical excitation at 400 nm.

### Example 8

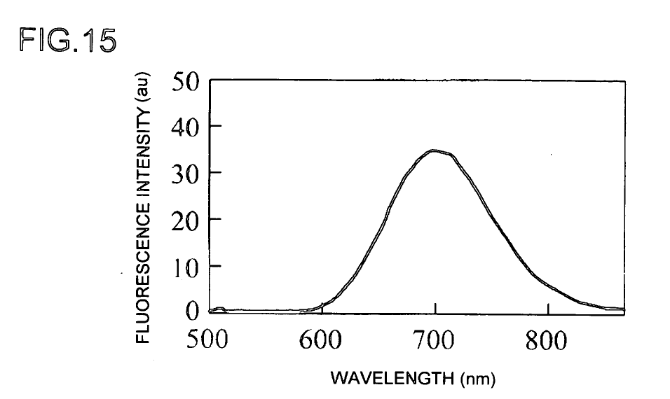

Example 8 shows an example of producing a phosphor of the present invention. Synthesis was carried out using thioacetoamide as a sulfur source, and dodecanethiol as a solvent and complexing agent. Copper iodide and indium iodide were completely dissolved in the dodecanethiol followed by the addition of thioacetoamide and heating for 22 hours at a temperature of 100° C. to obtain a product. The fluorescence spectrum of the resulting product is shown in FIG. 15. Fluorescence was obtained having a fluorescence wavelength of about 700 nm as a result of optical excitation at 460 nm.

The present invention is used advantageously in the following fields.

A phosphor of the present invention can be used as a phosphor containing semiconductor nanoparticles capable of carrying out modification, staining and so on of bio-related substances. A phosphor containing nanoparticles of the present invention exhibits various fluorescence of 450 to 800 nm as a result of monochromatic excitation, and the nanoparticles demonstrate high stability. Consequently, in addition to applications as a fluorescent reagent for biomolecular analyses typically used at present in biochemical research and diagnostics, a phosphor of the present invention can be expected to be used in a wide range of other applications, including as a fluorescent tag for observation of the kinetics of biomolecules and as a fluorescent tag for simultaneous analysis of multiple types of molecules.

Moreover, since this nanoparticle phosphor is composed of lowly toxic elements and enables fluorescent color to be controlled as desired over a range of 450 to 800 nm corresponding to the range of visible light to near infrared light, it can be used as an optical material over an extremely wide range, including as a phosphor used in EL displays, plasma displays and field emission displays, as a phosphor for light-emitting diodes and as a phosphor for use in lasers. In addition, it can also be used as a semiconductor light source for illumination.

1. A phosphor in the form of composite particles or composite compound comprising a first compound composed of elements of groups I, III and VI having a chalcopyrite structure, and a second compound composed of elements of groups II and VI or elements of groups III and V, wherein
the particle diameter of the first compound, or the composite particles or the composite compound, is 0.5 to 20.0 nm.

2. The phosphor according to claim 1, wherein the first compound is a solid solution having a chalcopyrite structure.

3. The phosphor according to claim 1, wherein the second compound is a metal chalcogenite compound.

4. The phosphor according to claim 1, wherein the lattice mismatch ratio between the first compound and the second compound is 5% or less.

5. The phosphor according to any of claim 1, wherein the molar ratio of the group II element of the second compound to the group I element of the first compound is 0.05 to 3.00.

6. The phosphor according to claim 5, wherein the first compound is composed of copper (Cu) or silver (Ag), indium (In) or gallium (Ga), and chalcogen, and
is produced from raw materials of group 2 metal, copper (Cu) or silver (Ag), indium (In) or gallium (Ga) and chalcogen at a composite ratio of 1:A:B:4, with A being 0.5 to 5.0 and B being 0.5 to 5.0.

7. The phosphor according to claim 5, wherein the first compound is excited by excitation light, and the quantum efficiency at which light waves are emitted following the excitation is 0.1% to 10.0% at room temperature.

8. The phosphor according to claim 5, wherein the fluorescence emitted by the first compound is light having a wavelength of 450 to 800 nm.

9. A process for producing a phosphor comprising: mixing a first solution, in which a raw material salt of a plurality of types of elements composing a compound of groups I, III and VI having a chalcopyrite structure is dissolved and mixed in a solution to which has been added a complexing agent which coordinates to the plurality of types of elements, and a second solution in which a chalcogenite compound has been dissolved, and heat-treating the mixture under predetermined heating conditions.

10. The process for producing a phosphor according to claim 9, wherein the group I element is copper (Cu) or silver (Ag),
the group III element is one type of element selected from indium (In), gallium (Ga) and aluminum (Al), and
the group VI element is one type of element selected from sulfur (S), selenium (Se) and tellurium (Te).

11. The process for producing a phosphor according to claim 9, wherein the predetermined heating conditions comprise mixing the first solution and the second solution and heat-treating the mixture at a temperature of 70 to 350° C. for a duration of 1 second to 30 hours.

12. The process for producing a phosphor according to claim 11, wherein the band gap of the phosphor particles, or the fluorescence wavelength emitted from the phosphor, is controlled by changing the heating conditions.

13. The process for producing a phosphor according to claim 9, wherein the first solution and the second solution are reacted by mixing in a micro-reactor having a flow channel of 50 μm to 5 mm, followed by heating.

14. The process for producing a phosphor according to any of claim 9, wherein the first solution is a solution in which a copper (I) salt or a copper (II) salt and an indium (III) salt are dissolved and mixed in a solution to which a complexing agent has been added which coordinates to copper (I) and indium (III).

15. The process for producing a phosphor according to claim 14, wherein the chalcogen compound is zinc sulfide (ZnS),
and the phosphor is produced from raw materials consisting of zinc (Zn), copper (Cu), indium (In) and sulfur (S) at a composite ratio of 1:A:B:4, with A being 0.5 to 5.0 and B being 0.5 to 5.0.

16. The process for producing a phosphor according to any of claim 9, wherein the first solution is a solution in which a silver (I) salt and an indium (III) salt are dissolved and mixed in a solution to which a complexing agent has been added which coordinates to silver (I) and indium (III).

17. The process for producing a phosphor according to claim 16, wherein the chalcogen compound is zinc sulfide (ZnS), and
the phosphor is produced from raw materials consisting of zinc (Zn), silver (Ag), indium (In) and sulfur (S) at a composite ratio of 1:A:B:4, with A being 0.5 to 5.0 and B being 0.5 to 5.0.

18. The process for producing a phosphor according to claim 15, wherein the band gap of the phosphor particles, or the fluorescence wavelength emitted from the phosphor, is controlled by changing the composite ratio.
